(19) United States
(12) Patent Application Publication
(10) Pub. No.: US 2002/0093191 A1
(43) Pub. Date: Jul. 18, 2002

(54) Single sheet mailer having a gift certficate or the like

(76) Inventors: Jenny C. Feng, (US); Brian R. McCarthy, Anaheim Hills, CA (US)

Correspondence Address: DOUGLAS N. LARSON, ESQ., OPPENHEIMER WOLFF & DONNELLY LLP, 2029 Century Park East, Suite 3800, Los Angeles, California, CA, 90067, US

(21) Appl. No.: 09/942,085

(22) Filed: Aug. 28, 2001

Related U.S. Application Data
(60) Provisional application No. 60/248,468, filed on Nov. 14, 2000.

(51) Int. Cl. B42D 15/00

(52) U.S. Cl. 283/116; 283/57; 283/61; 283/62

(57) ABSTRACT

A sheet mailer construction including a standard size paper sheet having two horizontal score lines and two horizontal perforation lines, forming a top flap, first and second panels, a tear-off panel and a bottom tear-off strip. Left and right vertical perforation lines define left and right sheet side edge tear-off strips. The user on his personal computer formats the desired indicia to be printed on the three panels using his (desk top ink jet) printer. After printing, the left side, right side and bottom tear-off strips are torn off, the tear-off panel is folded up towards the second panel, the first and second panels are folded together, and the top flap is folded onto the outside of the second panel. The mailer is mailed to the recipient who breaks the seal of the sticker holding the top flap to the second panel, unfolds the mailer, reads the printed information on the inside surfaces of the first and second panels, and tears off the tear-off panel. The torn-off, stand-alone printed panel forms a gift certificate, coupon or other document.

### CROSS-REFERENCE TO RELATED APPLICATION

This application claims the benefit of U.S. Provisional Application Serial No. 60/248,468 filed Nov. 14, 2000, whose contents are hereby incorporated by reference in its entirety.

### BACKGROUND OF THE INVENTION

Gift certificates, coupons and the like, when prepared for mailing to intended users, are typically printed in a separate printing operation from the addressing of their envelopes and are formed from separate sheets of paper from the envelopes.

### SUMMARY OF THE INVENTION

Directed to remedying the problems in the prior art, disclosed herein is a mailer sheet construction which includes a (standard-sized 8½ by 11 inch) sheet of paper which is adapted to be passed through a desk top ink jet printer or the like, including color laser. The printer prints the user's custom-designed address indicia on a backside of a first panel of the sheet, advertising/message indicia on an inside of the first and/or second panels of the sheet, and document indicia on an inside surface of a tear-off panel of the sheet. After the printing operation, the user tears off left side, right side and bottom tear-off strips of the sheet. He then folds the tear-off panel towards the inside of the second panel, the second panel towards the inside of the first panel and the top flap towards the backside of the second panel. The top flap is adhered, as with an adhesive sticker, to the second panel, postage is applied to the backside of the first panel and the mailer thereby formed is mailed to an intended recipient.

The recipient, when he receives the mailer, opens it, reads the advertising/message indicia, and tears off the tear-off panel. The tear-off panel, with its custom printed document indicia thereon, forms a document, separate from its envelope-mailer. The document can be a coupon, a gift certificate or the like. And the advertising/message indicia can explain or be otherwise related to the document indicia of the coupon, gift, certificate or the like.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a top plan view of a mailer sheet of the present invention;

FIG. 2 is a perspective view of a stack of the mailer sheets of FIG. 1 in an infeed tray of a printer (or copier) and a stack of printed mailer sheets in the output tray thereof;

FIG. 3 is a perspective view of a printed mailer sheet from the output tray of FIG. 2 showing the left side, right side and bottom tear-off strips being torn off and an initial folding step being conducted;

FIG. 4 is a view of the printed mailer of FIG. 3 showing subsequent folding steps;

FIG. 5 is a perspective view of the back side of the folded mailer of FIG. 4 showing an adhesive sticker or mailing seal being applied;

FIG. 6 is a perspective view of the mailer of FIG. 5 being opened by the recipient; and

FIG. 7 is a perspective view of the opened mailer of FIG. 6 showing the “gift certificate” portion being torn off.

### DETAILED DESCRIPTION OF THE PREFERRED EMBODIMENTS

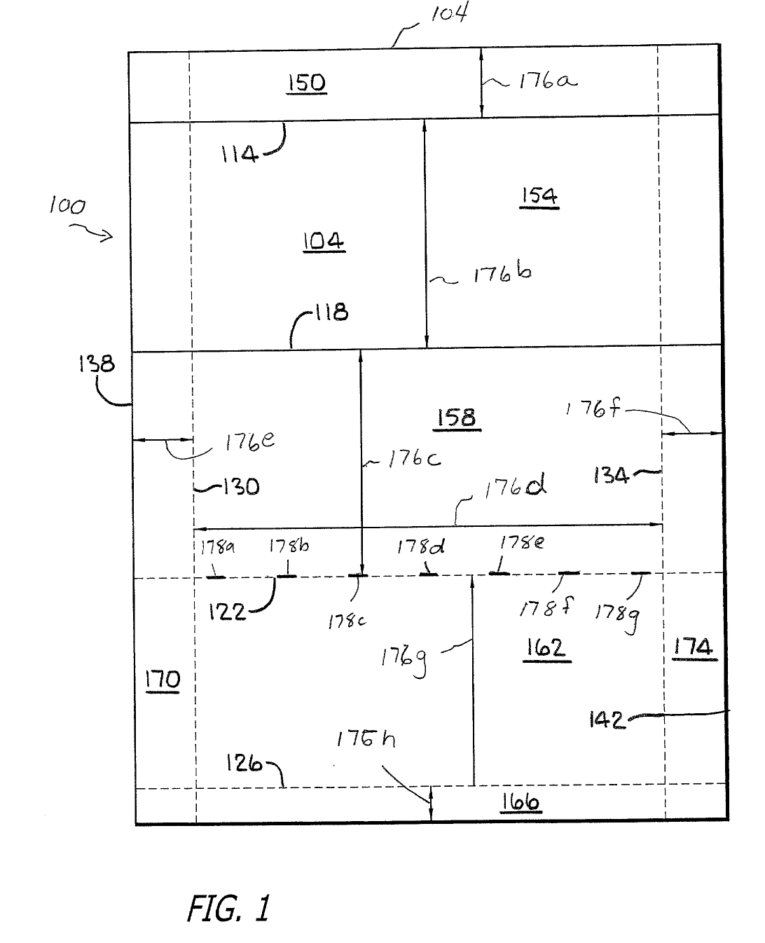

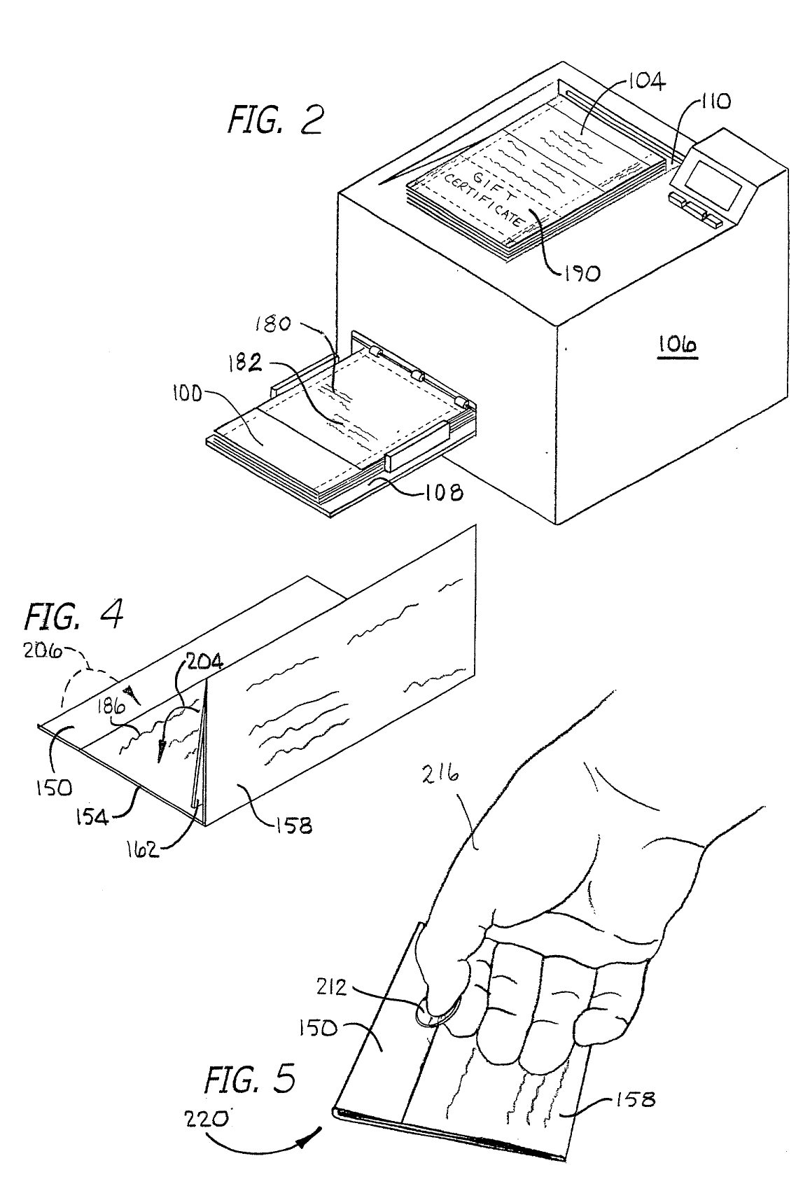

Referring to the drawings a mailer sheet construction of the present invention is shown in the drawings and in particular in isolation in FIG. 1 generally at 100. Mailer sheet construction 100 includes a standard-size sheet 104 having preferred dimensions of 8½ by eleven inches so that it can be easily fed into and passed through today's printers or copiers, such as printer 106 shown in FIG. 2, and having an input tray 108 and an output tray 110. The sheet can be a paper sheet having ink jet receptive coatings on both sides and a thickness of 8.5 mils. And the printer 106 is preferably a desk top ink jet printer.

Sheet 104 includes a pattern of weakened lines formed thereon and preferably on the inside surface of the sheet. The weakened lines are provided to either aid in the accurate folding or tearing of the sheet 104 along the desired lines. The fold lines are preferably score lines and can be either cut score lines or crushed score line; and the tear lines are preferably perforated or microperforated lines. An example perforated line uses a 0.020 inch cut and a 0.007 inch tie. The crushed score lines can be formed using a single crush die on the inside of the sheet and a flat die on the opposite side. However, other types of fold and/or tear lines as would be apparent to those skilled in the art are within the scope of this invention. Two different die stations can be used to form the sheet construction, wherein one die includes all of the horizontal perforations and scores and the other has all of the vertical ones. It typically does not make any difference which station is first in the manufacturing process.

The lines include first and second horizontal score lines 114, 118 extending the width of the sheet, first and second horizontal perforation lines 122,126 extending the width of the sheet and parallel to and below the score lines, and vertical side perforation lines 130, 134 spaced a little less than an inch from respective side edges 138,142 of the sheet. The lines 114, 118, 122, 126 divide the sheet into a top flap 150, first and second panels 154, 158, a tear-off panel 162, a bottom tear-off strip 166, and left and right side tear-off strips 170, 174. Exemplary dimensions, referring to the reference numerals in FIG. 1, are 176a (one inch), 176b (3¼ inches), 176c (¾ inches), 176d (6¾ inches), 176e (⅞ inch), 176f (⅞ inch), 176g (three inches) and 176h (½ inch). Seven one-sixteenth inch ties 178a, 178b, 178c, 178d, 178e, 178f, and 178g are provided on perforated line 122, spaced equidistant from each other. The distance between tie 178a and line 130 (and similarly between tie 178g and line 134) can be one-eighth inch.

The user using suitable software designs on his computer (not shown) the indicia to be printed on the sheet 104 at the desired locations on the sheets. This indicia can include sender's and intended recipient's address indicia 180, 182 on the backside of the first panel 154. It further can include message, information, advertising or other indicia 186, 188 on the inside surfaces on the first and/or second panels 154, 158. It further can include document indicia 190 on the inside surface of the tear-off panel 162. Additionally, it can include instructional, trademark, copyright, patent other informational indicia 194 on the left and/or right side tear-off strips 170,174 on the inside or backside surfaces thereof.

It is anticipated that pursuant to one preferred use of the invention a large number of sheets will be printed at the same time and all will have identical indicia except the recipient's address 182 and maybe a salutatory greeting such as “Dear Mr. Smith,” on the inside of the first panel, for example. And the recipient's address 182 can be taken from an existing file listing which is copied into the mailer indicia software.

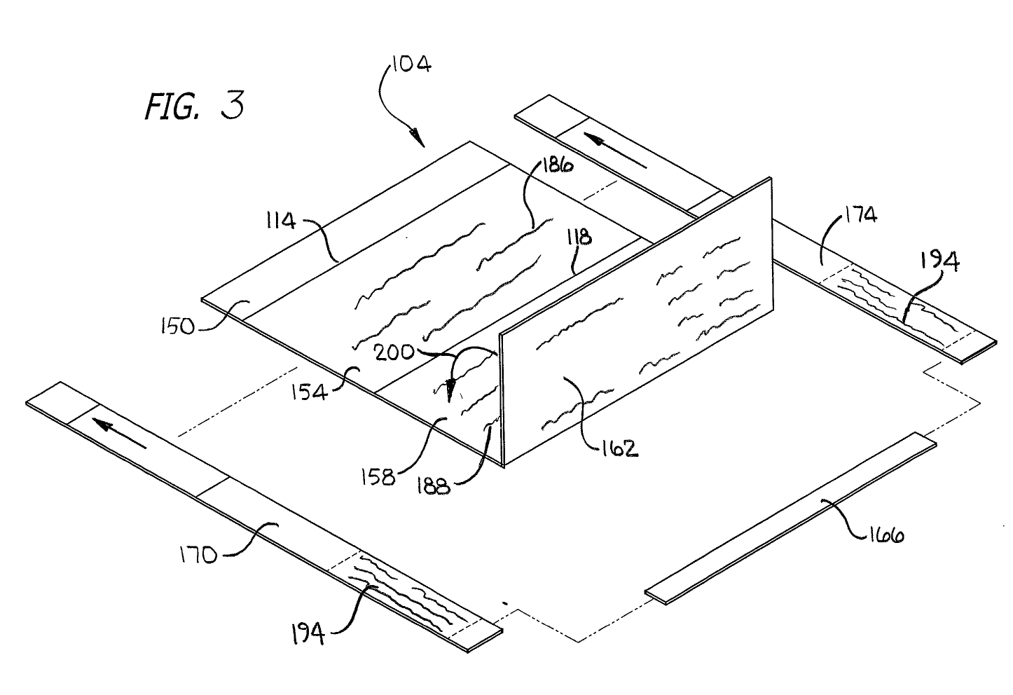

After the sheet 104 has been printed either with two passes through the printer 106 or a single pass through a duplexing printer, the printed sheet is removed from the printer output tray 110, as shown in FIG. 2. Referring to FIG. 3, the left, right and bottom tear-off strips 170,174, 166 are torn off along their respective perforation lines 130,134,126 by the user. The tear-off panel 162 is folded up, also as depicted in FIG. 3 by arrow 200. The second panel 158 is folded up onto the first panel 154 as shown by arrow 204 in FIG. 4. And the top flap 150 is folded down onto the outside of the folded-down second panel 158, as shown by arrow 206. A sticker or mailing seal (having a perforated line) 212 is removed from a sheet (not shown) of same and applied by the user 216 to top flap 150 onto the second panel 158, as shown in FIG. 5. A stamp, if not previously applied, is adhered to the outside of the first panel 154 to form the mailer shown generally at 220 in FIG. 5. The mailer 220 is then mailed to the recipient 230.

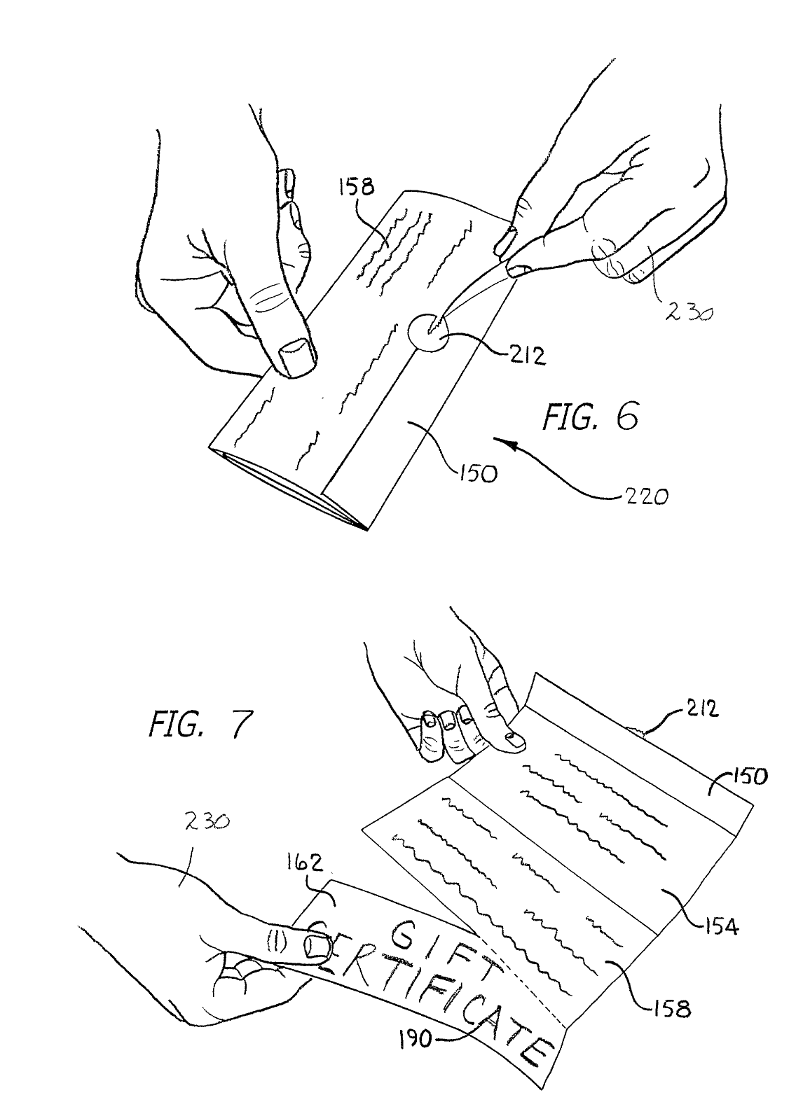

The recipient 230 receives the mailer 220, breaks the sticker 212, as depicted in FIG. 6, and unfolds the mailer. He reads the printed indicia on the inside surfaces of the first and second panels 154, 158. Referring to FIG. 7, the recipient 230 then tears off the tear-off panel 162 along line 122, breaking ties 178a-g, to form a separate single sheet document which is preferably a rectangle of three inches by almost seven inches. The document 162, depending on the indicia 186 printed thereon, can be a coupon, a gift certificate or the like.

Thus, the present invention provides a sheet 104 which can be easily formatted as desired by the user and fed into and printed on by the user's desk top ink jet printer 106. The user can use it, for example, as an advertisement with an attached gift certificate 162 for the user's establishment. The message, gift certificate and addresses are advantageously custom printed in a single printing operation by the user on his own desk top printer 106. The sheet 104 can be sold in a stack of similar sheets in a package (not shown), such as a bag, carton or paper wrapping.

From the foregoing detailed description, it will be evident that there are a number of changes, adaptations and modifications of the present invention which come within the province of those skilled in the art. The scope of the invention includes any combination of the elements from the different species or embodiments disclosed herein, as would be within the skill in the art. However, it is intended that all such variations not departing from the spirit of the invention be considered as within the scope thereof.

We claim:

1. A sheet mailer construction, comprising:
a sheet having top, bottom, left side and right side edges;
the sheet having first, second and third weakened lines parallel to one another and to the top and bottom edges;
the sheet having a flap defined at its lower edge by the first line, a first panel defined by the first and second lines, a second panel defined by the second and third lines and a tear-off panel defined at its upper edge by the third line; and
the sheet after passing through a printer and a printing operation conducted on at least one of the first panel, the second panel and the tear-off panel, can be folded to form a mailer by folding on the third line, on the second line and on the first line such that the tear-off panel is positioned between the first and second panels, and the flap can be folded over and attached to the second panel; and wherein the mailer can be subsequently opened by detaching the flap from the second panel and the tear-off panel separated from the second panel by tearing along the tear-off line to form a stand-alone document.

2. The construction of claim 1 wherein the document is a gift certificate.

3. The construction of claim 1 wherein the document is a coupon.

4. The construction of claim 1 wherein the printing operation is on the tear-off panel.

5. The construction of claim 1 wherein the printing operation is on a back side of the first panel and includes a mailing address.

6. The construction of claim 1 wherein the printing operation is on front sides of at least one of the first and second panels.

7. The construction of claim 1 further comprising a sticker which attaches the flap to a back side of the second panel to form the mailer.

8. The construction of claim 1 wherein the sheet includes a first weakened separation line parallel to and spaced from the left side edge and defining therewith a first tear-off strip, and a second weakened separation line parallel to and spaced from the right side edge and defining therewith a second tear-off strip.

9. The construction of claim 8 wherein the first and second tear-off strips are adapted to be torn off after the printing operation and thereby do not form part of the mailer.

10. The construction of claim 8 wherein the first and second weakened separation lines comprise perforated lines.

11. The construction of claim 8 wherein the first and second tear-off strips are on opposite sides of the flap, first and second panels and tear-off panel.

12. The construction of claim 1 wherein the first and second weakened lines are cut score lines.

13. The construction of claim 1 wherein the first and second weakened lines are crush score lines.

14. The construction of claim 1 wherein the third line is a perforated line.

15. The construction of claim 1 wherein the sheet is a paper sheet having ink jet receptive coatings on both sides thereof.

16. The construction of claim 1 the sheet includes a weakened separation line parallel to and spaced from the bottom edge of the sheet and defining a bottom edge of the tear-off panel.

17. The construction of claim 16 wherein the weakened separation line and the bottom edge of the sheet define a bottom tear-off strip adapted to be torn off after the printing operation, and thereby not form part of the mailer.

18. The construction of claim 1 wherein the sheet is an 8½ by 11 inch sheet.

19. The construction of claim 1 wherein the document is a single layer sheet.

20. The construction of claim 1 wherein the document consists of a single layer sheet with printing thereon.

21. The construction of claim 1 wherein the sheet is a single ply of paper.

22. The construction of claim 1 wherein the printer is a desk top ink jet printer.

23. The construction of claim 1 wherein the printer is a color laser printer or a monochrome laser printer.

24. A sheet mailer construction, comprising:
a sheet having horizontal and vertical weakened lines defining a top flap, a first panel foldable with respect to the top flap, a second panel foldable with respect to the first panel, a tear-off panel adapted to be torn off from a bottom edge of the tear-off panel, a bottom tear-off strip adapted to be torn off from a bottom edge of the second panel, a left side tear-off strip extending between top and bottom edges of the sheet, and a right side tear-off strip extending between the top and bottom edges of the sheet;
the sheet having after having passed at least once through a printer having address indicia printed on an outside surface of the first panel, document indicia printed on an inside surface of the tear-off panel, and message/advertisement indicia printed on an inside surface of at least one of the first and second panels;
a sticker for adhering the top flap to the backside surface of the second panel, after the tear-off strips and tear-off have been torn off, and the panels and top flap folded to define a mailer; and
the horizontal weakened line separating the tear-off panel from the second panel comprising a perforation line which allows the tear-off panel with the document indicia printed thereon to be separated from the second panel after the mailer has been opened so that the printed tear-off panel thereby defines a separate document.

25. The construction of claim 24 wherein the separate document is a coupon.

26. The construction of claim 24 wherein the separate document is a gift certificate.

27. The construction of claim 24 wherein the weakened separation lines between the top flap and the first panel and between the first panel and the second panel are score lines.

28. The construction of claim 27 wherein the score lines are cut score lines.

29. The construction of claim 27 wherein the score lines are crushed score lines.

30. The construction of claim 27 wherein the tear-off panel is a three inch by 6¾ inch rectangle.

31. A method of forming a mailer, comprising:
providing a sheet having horizontal and vertical weakened lines defining a top flap, a first panel foldable with respect to the top flap, a second panel foldable with respect to the first panel, a tear-off panel adapted to be torn off from a bottom edge of the second panel, a bottom tear-off strip adapted to be torn off from a bottom edge of the tear-off panel, a left side tear-off strip extending between top and bottom edges of the sheet, and a right side tear-off strip extending between the top and bottom edges of the sheet;
passing the sheet through a printer and printing indicia on at least an inside surface of the tear-off panel and of at least one of the first and second panels, and on a backside surface of the first panel;
after the printing, folding the tear-off panel towards the second panel, the second panel towards the first panel, and the top flap towards the backside of the second panel; and
adhering the top flap towards the backside of the second panel to define a mailer.

32. The method of claim 31 further comprising after the adhering, opening the mailer and tearing the tear-off panel off of the second panel.

33. The method of claim 32 wherein the adhering includes applying a mailing seal to the top flap and the second panel.

34. The method of claim 31 wherein after the printing, the tear-off panel comprises a gift certificate.

35. The method of claim 31 wherein after the printing, the tear-off panel comprises a coupon.

36. The method of claim 31 wherein the adhering includes applying an adhesive sticker to the top flap and the second panel.

37. The method of claim 31 further comprising before the printing, custom designing the indicia on a user's personal computer.
